(19) United States
(12) Patent Application Publication
(10) Pub. No.: US 2007/0007316 A1
(43) Pub. Date: Jan. 11, 2007

(54) Bicycle carrier

(76) Inventor: John Witczak, Greenfield Park (CA)

Correspondence Address: Franz BONSANG;c/o PROTECTIONS EQUINOX INT'L INC., Suite 224, 4480, Cote-de-Liesse, Montreal, QC, H4N 2R1, CA

(21) Appl. No.: 11/176,377

(22) Filed: Jul. 8, 2005

(51) Int. Cl. B60P 9/00; B60R 9/00

(52) U.S. Cl. 224/310; 224/924; 414/462

(57) ABSTRACT

A bicycle carrier provides a rotatable beam on which are mounted foldable support arms having first wheel support means for engaging and entrapping the upper peripheral regions of the wheels of a bicycle, the beam being rotatable into a bicycle carriage mode vertically above the vehicle when the arms are in an arm deployed position and lockable in that position. Resiliently-biased detent means are associated with the support arms mountings for positively locking the arms in the deployed position in relation to the beam, simple movement against the bias effecting disengagement.

### FIELD OF THE INVENTION

The present invention concerns a bicycle carrier of the kind for use on a vehicle for the carriage of at least one bicycle externally thereof. In particular, the invention has reference to such a carrier for fixture to the vehicle roof for safe and secure stowage of a bicycle during transportation and provided with means for facilitating the mounting and dismounting of the bicycle in relation to the carrier and the vehicle.

### BACKGROUND OF THE INVENTION

Bicycle carriers are legion in terms of design and mode of use and with the burgeoning of interest in cycling as a pastime and indeed a sport for the masses, many and varied types of carriers have been proposed for all manner of vehicles. With the introduction of family vehicles capable of transporting a relatively large number of people, the need to address the practicalities of bicycle carriers has become more pressing. One of the problems attendant upon current and conventional bicycle carriers is that of being cumbersome and difficult to use by all members of the family. Additionally, given the differing designs available for bicycles manifest in varied frame shapes and configurations, problems have arisen in terms of carriers not being universally applicable for substantially all bicycles. Furthermore, versatility of application to diverse vehicle types and designs has proven to be a difficult goal to attain.

For example, U.S. Pat. No. 6,149,039 to Englander discloses a bicycle carrier which displays the shortcomings outlined above. In particular, it will be observed that the proposed structure is provided with complicated anchorages for securing the mounting legs used for supporting the bicycle in the carriage position, upright atop of the carrier and the vehicle. Furthermore, the manner of securement of the bicycle to the mounting legs is focused upon the frame of the bicycle, more especially the crossbar. Clearly for bicycles intended for female riders, such an arrangement would be inappropriate, thus yielding the carrier limited in its scope of usage.

Another example of bicycle carrier is depicted and described in U.S. Pat. No. 6,638,000 to Groves who essentially devised a lift for such a carrier involving the use of a rotatable shaft which upon actuation, either manually or by a motorized mechanism, causes a lift arm to be elevated or depressed in accordance with a requirement to raise or lower the arm for attachment or detachment of the bicycle. Moreover, the lift arm is provided with a supporting arrangement for the bicycle, which is adapted to engage and hold the relatively upper region of the bicycle frame, notably the handlebars and the saddle. Disadvantages of the Groves' approach are at least two-fold in that a special drive array is required to actuate the lift, and the clamping of the upper region of the bicycle is upon parts that are variably located dependent upon the configuration of the bicycle.

Accordingly, there is a need for an improved bicycle carrier that facilitates the placement of the bicycle on the carrier, the elevation and depression of the carrier support members, and that affords a versatility in terms of accommodating differing sizes and designs of bicycle.

### SUMMARY OF THE INVENTION

It is therefore a general object of the present invention to provide an improved bicycle carrier.

An advantage of the present invention is that the carrier presents support arms for the relatively upper perimeters of the bicycle wheels, which can be placed thereon individually at ground level with a minimum of effort.

Another advantage of the present invention is that the manner of supporting the wheels affords considerable versatility for accommodating a wide variety of bicycle designs for all family members.

Yet another advantage of the present invention is that the support arms are readily stowable in a parked, non-use, stowed position in relatively close adjacency to the roof of the vehicle and are manually movable into a working deployed position from ground level with a minimum of effort, the arms being lockable in the parked and the deployed position. Release of the arms from the locked condition requires a simple movement. The spaced disposition of the arms is conveniently variable to cater for differing bicycle dimensions.

Another advantage of the present invention is that the movement of the arms in the deployed position into a hitching mode wherein the bicycle may be mounted on the arms is effectively controlled by means of a damper thus preventing any sudden movement that might compromise safety.

A still further advantage of the instant invention is that the means for clamping the wheels in position are of relatively simple construction with quick release mechanisms for ease of use.

According to an aspect of the present invention, there is provided a bicycle carrier for releasably securing a bicycle to a roof rack of a vehicle, the bicycle carrier comprising a base frame securably mountable on the roof rack, a beam extending adjacent the roof rack longitudinally of the base frame and of the vehicle and rotatable relative thereto along a beam longitudinal axis lengthwise of the vehicle, a support arm spaced apart along the beam and pivotable relative thereto at a first end thereof between a stowed position adjacent the base frame and a deployed position, detent means associated with the support arm to retain the arm in the deployed position, first wheel support means disposed at a free second end of the support arm and adapted in use to clamp an upper region of a respective wheel of the bicycle to the arm, and second wheel support means provided on the beam for securing a lower region of the respective wheel to the beam, damper means associated with the beam for damping its rotational movement.

In one embodiment, the support arm is a first arm and said carrier further includes a second support arm spaced apart along the beam and pivotable relative thereto at a first end thereof, the detent means retaining the arms in the deployed position, the first wheel support means disposed at a free second end of respective the support arms and adapted in use to clamp an upper region of a respective wheel of the bicycle to the respective arm.

Typically, the first and second support arms pivot toward each other in a close side-by-side substantially overlying relationship relative to one another when being folded and away in a space-apart substantially parallel relationship relative to one another when being deployed.

A hinge pin is provided for the rotation of the beam and is mounted in the base frame. The beam may conveniently be provided with arm positioning means for longitudinally adjust positioning of respective the support arms therealong. The arm positioning means is typically formed with T-section slots cut in longitudinal faces of the beam and extending lengthwise thereof for interengagement with T-bolts provided to secure the support arms to the beam and to form wheel support positioning means to locate and fix the second wheel support means to said beam. In this manner, the positioning of the arms and of the second wheel support means lengthwise of the beam may be adjusted to accommodate differing dimensions as between differently designed bicycles.

The detent means are advantageously resiliently biased thereby to effect a degree of automaticity when the arms are moved from the stowed position to the deployed position to lock the arms in that position. Release from this locked condition is undertaken by a simple disengagement of the detent means to allow the arms to reassume a parked condition at an appropriate time.

The first wheel support means may be in the form of straps that are releasably securable to the upper peripheral region of the respective bicycle wheel, either the front wheel or the rear wheel. Conveniently they are flexible and yet of durable material and may be of proprietary design and manufacture.

The second wheel support means may be in the form of arcuate cradle mounts having suitable straps for ease of attachment when the respective bicycle wheels are in the vertical or substantially vertical carriage position on the carrier atop a vehicle.

The damper means may be of any convenient type, but a hydraulic cylinder may preferably be employed for the purpose.

In one embodiment, the bicycle carrier includes locking means to secure the beam when in a parked position. The locking means typically comprises a hooked lever resiliently biased into engagement with a cross pin associated with the beam, and release means to effect disengagement thereof as desired.

Conveniently, the locking means includes a movement limiting means for limiting the rotational movement of the beam when in a depending position for loading and unloading the bicycle therefrom.

Typically, the locking means includes a locking bar associated with the damper means and the base frame, the locking bar being provided with a lock that in its locked mode secures the beam in an upright position in which the support arms are either folded into the stowed position or locked in the deployed position upstanding in relation to the beam when in use carrying the bicycle. Conveniently, when the support arms are folded into the stowed position, the lock when in its locked mode secures the beam in an upright position and the support arms in the stowed position.

According to another aspect of the present invention, there is provided a bicycle carrier for releasably securing a bicycle to a roof rack of a vehicle, the bicycle carrier comprising a base frame securably mountable on the roof rack, a beam extending adjacent the roof rack longitudinally of the base frame and of the vehicle and rotatable relative thereto along a beam longitudinal axis lengthwise of the vehicle, two support arms spaced apart along the beam and pivotable relative thereto at a respective first end thereof between a stowed position adjacent the base frame and a deployed position, detent means associated with the support arms to retain the arms in the deployed position, first bicycle support means disposed at a respective free second end of the support arms and adapted in use to clamp a respective upper region of the bicycle to the arm, and second bicycle support means provided on the beam for securing a respective lower region of the bicycle to the beam, damper means associated with the beam for damping its rotational movement.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of a bicycle carrier of the present invention will become better understood with reference to the description in association with the following Figures, in which similar references used in different Figures denote similar components, wherein:

FIG. 1 is a top perspective view of a bicycle carrier in accordance with an embodiment of the present invention in a parked position;

FIG. 1a is a plan view corresponding to the view shown in FIG. 1;

FIG. 2 is a perspective view of a detail of a locking means of the carrier in one unlocking disposition with only the locking bar open and the beam in the parked position;

FIG. 3 is a perspective view corresponding to that of FIG. 2 with the locking means in a second unlocking disposition with the locking bar open and the beam slightly rotated from the parked position;

FIG. 4 is a top perspective view of the carrier with the support arms thereof shown having been moved into a deployed position;

FIG. 5 is a side perspective view of the carrier in a depending position beside a vehicle shown in dotted outline with a bicycle supported by the first wheel support means;

FIG. 6 is a top perspective view of the carrier in an elevated working position with the support arms locked in said position and the lower regions of the wheels secured in the second wheel support means;

FIGS. 7 through 10 are views of the detent means associated with the support arms in various stages of engagement and disengagement with parts exploded for the sake of clarity and explanation; and

FIGS. 11 and 12 show the first wheel support means in respectively partially closed and open positions.

### DETAILED DESCRIPTION OF THE PREFERRED EMBODIMENTS

With reference to the annexed drawings the preferred embodiments of the present invention will be herein described for indicative purpose and by no means as of limitation.

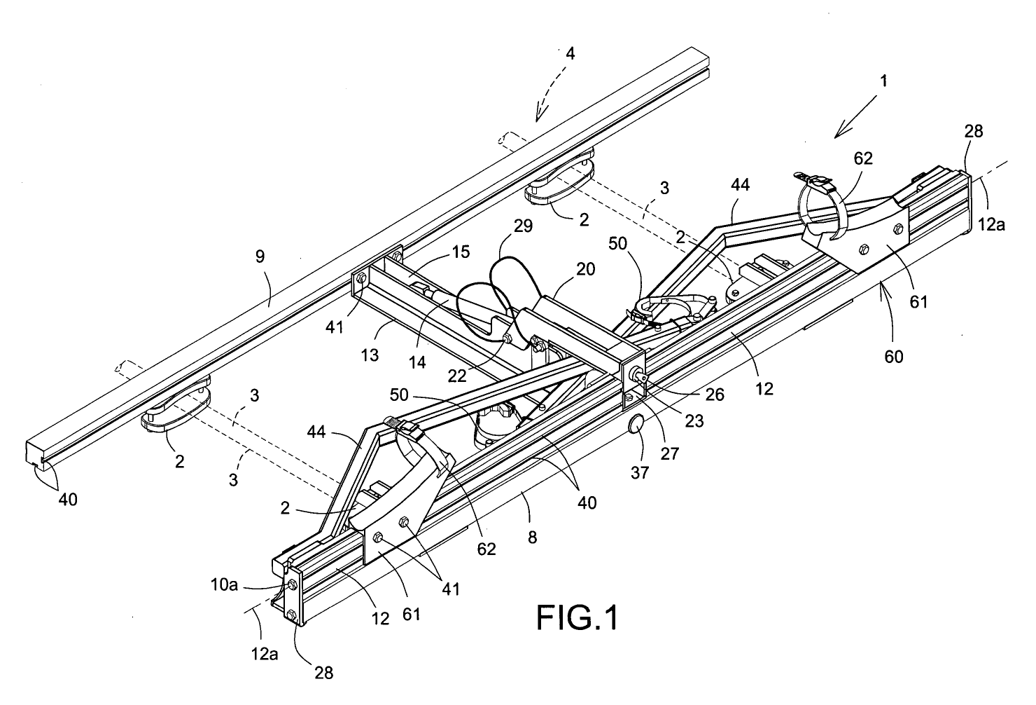

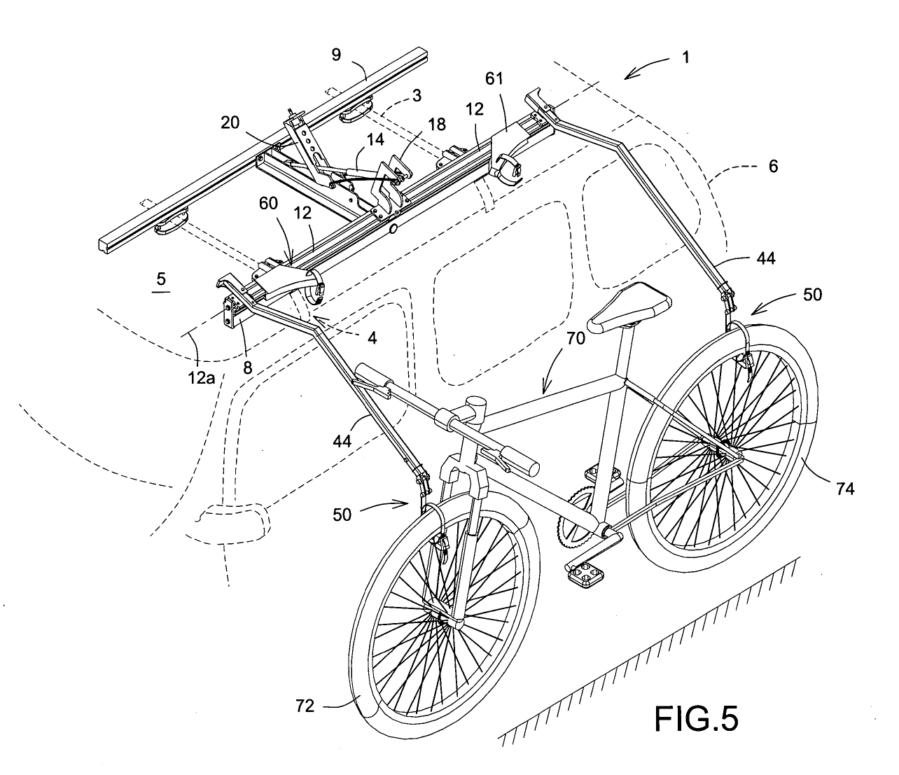

Referring to the figures, there is shown a bicycle carrier 1 in accordance with an embodiment of the present invention for releasably securing a bicycle 70 to a roof rack 4 mounted on the roof 5 of a vehicle 6 (see FIG. 5). The carrier 1 is typically provided with four mounts 2 for securing to transversal bars 3 of the roof rack 4. The carrier 1 includes a base frame 8 extending longitudinally of the vehicle 6, the base frame 8 being provided with a central hinge pin 10, and typically two end hinge pins 10a collinear to central hinge pin 10, mounted on a central bracket 27 and end brackets 28, respectively, (see FIGS. 1, 2 and 3) about which a beam 12 (or typically two half-beams as shown in the figures) is rotatable about a beam longitudinal axis 12a between a beam parked position when the carrier 1 is either in use carrying a bicycle 70 or not in use and stowed (see FIGS. 1, 1a, 2, 4 and 6) and a beam depending position for loading and unloading the bicycle there from (see FIGS. 5 and 7 to 10). An inner frame bar 9 is provided on the side of the roof 5 substantially parallel to and inwardly from the base frame 8. A transverse truss 13 extends between the base frame 8 and the frame bar 9 and is recessed as at 15 to accommodate a typically hydraulic damper 14 the free end of the piston rod of which is pivoted to the truss 13 as at 16. The other end of the damper 14 has its cylinder pivoted to a cross pin 17 provided in a yoke 18 secured to and mounted through the agency of a plate 19 on the relatively inner face of the beam 12 at approximately its mid point.

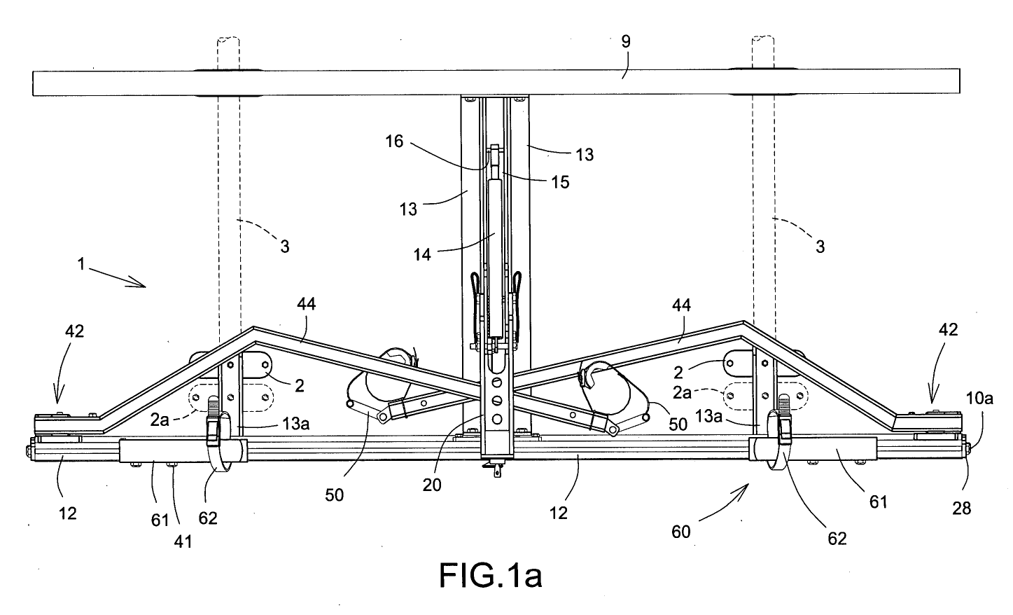

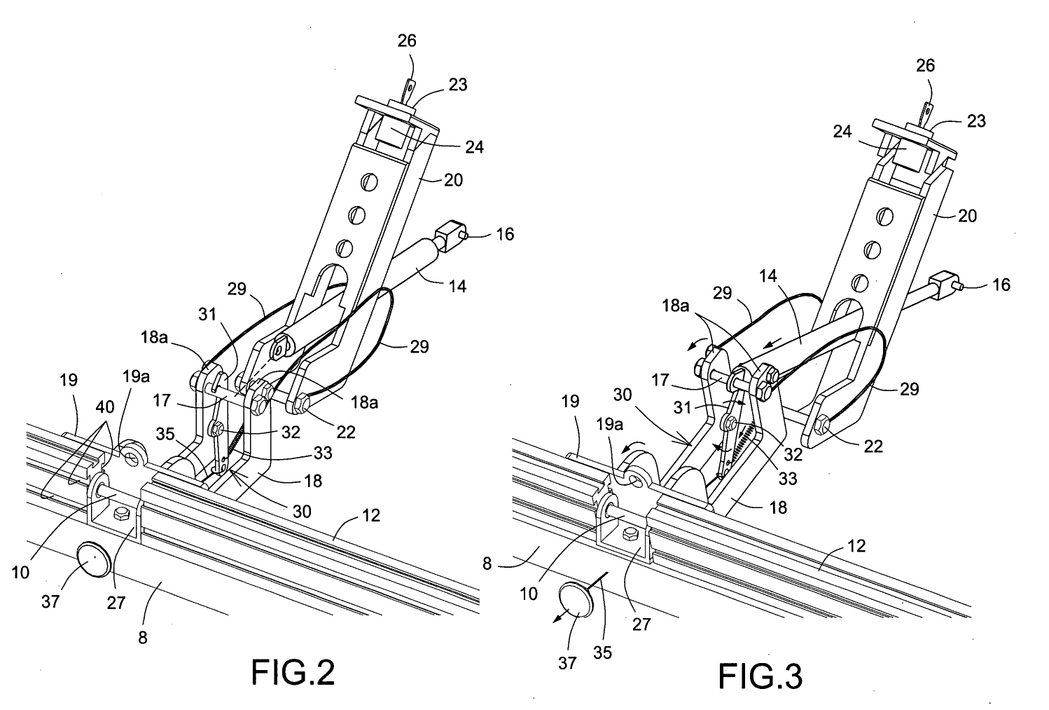

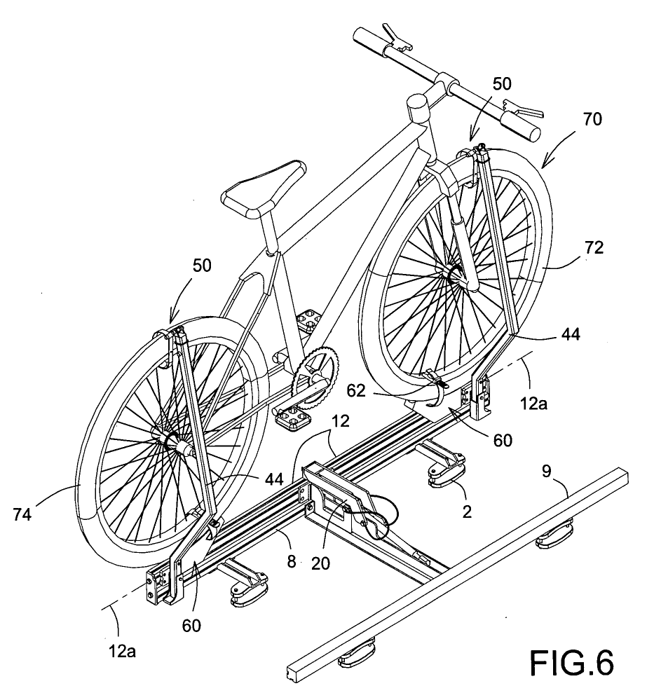

A locking means in the form of a locking bar 20 is pivoted at 22 to the transverse truss 13 and is provided with a lock 23 including lock cylinder 24 and a key 26 activating a locking pin 25, the locking pin 25 interengaging a pin hole 19a extending through plate 19 associated with beam 12. Movement limiting means such as cables 29 or the like are provided intermediate the bar 20 and the yoke 18 to limit the rotational movement of the beam 12 in the depending position as shown in FIGS. 5 and 7 to 10. A locking latch 30 in the form of a hooked lever 31 is pivotally mounted on the truss 13 at 32 and is resiliently-loaded by a spring 33 into hooked engagement with the cross pin 17 when in the parked position in which the locking bar 20 abuts a top surface 18a (see FIGS. 2 and 3) of the yoke 18 to resist and take the load against any movement thereof to stabilize the carrier 1, as seen in FIGS. 1 and 6. A release means to effect disengagement or unlatch of the hooked lever 31 from the cross pin 17 as desired is provided in the form of an operating wire 35 connected to the other end of the lever 31 and extends through the base frame 8, terminating in an operating knob 37.

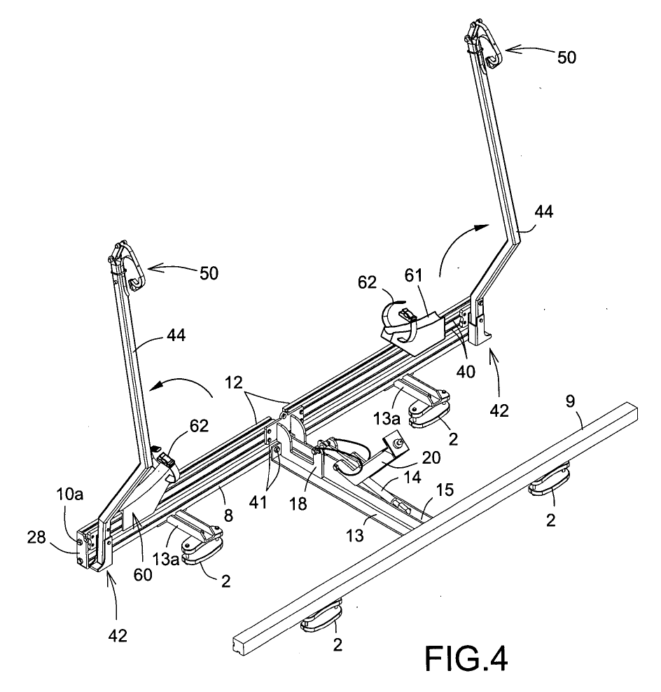

The beam 12 is typically of substantially square section and has formed in each of its faces T-section slots 40 (also preferably found on lower and inner faces of base frame 8 and frame bar 9 as shown in FIGS. 1 and 4) with which T-bolts 41 are engageable to secure different components thereto. The T-section slots 40 act as arm positioning means and second wheel support positioning means to longitudinally adjust the respective positions of two support arms 44 and two second wheel support means 60 thereon. Accordingly, some of the T-bolts 41 are provided to secure in adjustable fashion the mounting brackets 42 of the support arms 44 and the second wheel support means 60 as detailed hereinbelow. The adjustable nature of the positioning of the bolts 41 enables the brackets 42 and second support means 60 to be suitably disposed to accommodate variable spacing without compromising appropriate securement. Obviously, other types of position means such as for example pluralities of through holes extending through the beam 12 and typically equally spaced apart by approximately half an inch (½ inch or 15 mm) could be considered without departing from the scope of the present invention.

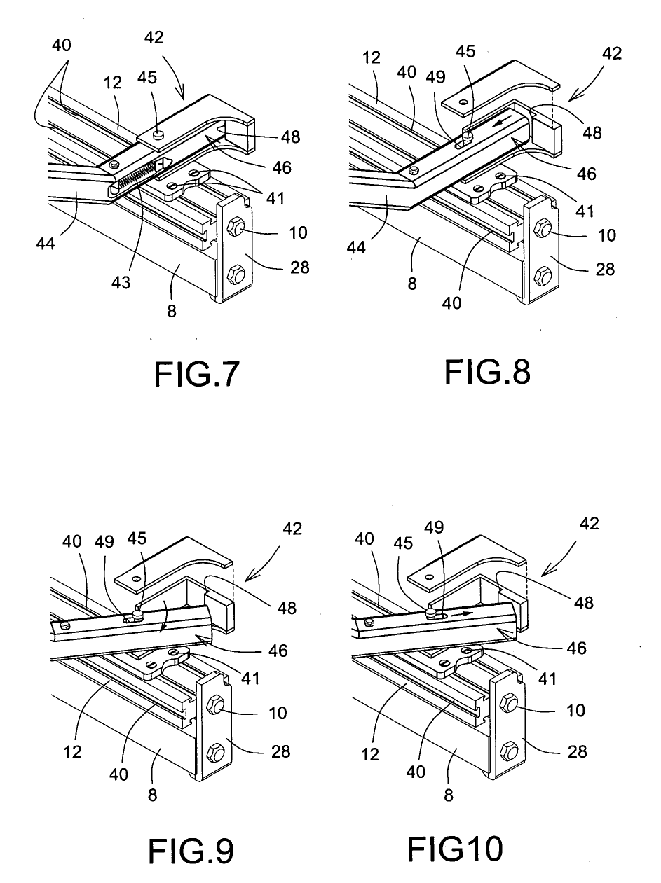

Each support arm 44 is substantially parallel to the beam 12 and is of dog-leg shape as seen in plan (FIG. 1a) in a stowed or parked position. In the stowed position, the two arms 44 are typically in a close side-by-side substantially overlying relationship relative to one another. Each support arm 44 is pivotally mounted within a respective mounting bracket 42 at a first end thereof about a pivot pin 45 and provided with resiliently-biased, via tension spring 43, detent means 46 (see FIGS. 7 to 10) which register with steps 48 within the mounting brackets 42 just after a longitudinal translation movement of the arm 44 allowed by pin 45 engaging a through slot opening 49 of the arm 44 (see FIGS. 8 and 10). The interrelationship as between the detent means 46 and the steps 48 is such that positive registration occurs upon pivotal movement of the arms about the pivot pin 45 (see FIG. 9) from the stowed position into a deployed or working position substantially perpendicular to the beam 12, namely an erect position in relation to the beam as shown in FIG. 4. In the deployed position, the two arms 44 are typically away and in a space-apart substantially parallel relationship relative to one another.

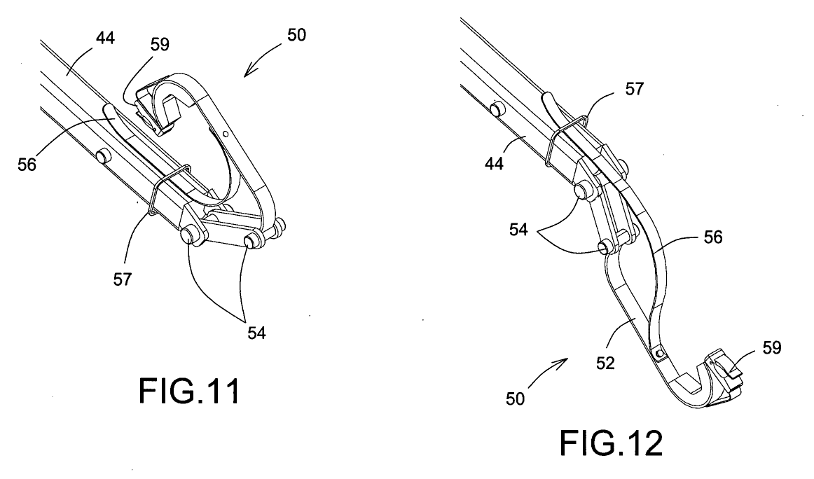

At a free second end of each support arm 44 is a first wheel support means in the form of a releasable clamp 50 shown in greater detail in FIGS. 11 and 12. The clamps 50 are of a proprietary nature and essentially consist of an arm hook extension 52 freely pivotable at 54 to the free end of the respective arm 44 with a semi-rigid flexible strap 56 secured thereto which is releasably reeved through a keeper 57 to provide some springy retention effect to the hook extension 52 during loading and unloading of the bicycle wheel there from before clamping around the bicycle wheel and securable within a ratchet buckle 59.

Second wheel support means 60 are of arcuate form in the form of a cradle 61 at least in part to substantially conform the contour of a wheel 72, 74 and are disposed so as to accommodate and positively locate a lower and preferably inner region of a respective wheel 72, 74 (see FIG. 6), a flexible strap 62 being provided in practice to wrap around and secure the lower region of the wheel within its respective cradle.

In use the bicycle carrier 1 of the invention is installed on any roof rack 4 of the roof 5 of a vehicle 6, for example an SUV (Sport Utility Vehicle) or the like, as shown in FIG. 5 and FIGS. 1 and 1a depict the carrier in its inoperative, unused or parked position with the support arms 44 lying adjacent the roof 5 in this example in overlapped disposition. The locking bar 26 is shown in a locking condition in which the lock is engaged and the arms of the carrier may not be erected.

The following procedure is adopted to deploy the carrier into a working mode and to fix a bicycle 70 thereto and elevate the same onto the roof of the vehicle:
1. The locking bar 20 is unlocked and pivoted from a generally horizontal position to the position shown in FIG. 2;
2. The left hand arm 44 (as viewed in FIG. 1) is then raised until the detent means clicks into position (see FIGS. 4 and 7);
3. The right hand arm 44 is raised in similar manner (see FIG. 4);
4. The wheel cradles 61 are unbuckled (see FIG. 4);
5. The knob 37 is then pulled to release the lever 31 from the cross pin 17 to allow the beam 12 to pivot-with the limitation provided by the damper in this direction toward the depending position, thereby bringing the arms 44 into a substantially horizontal position as shown in FIG. 5 alongside the vehicle;
6. The ratchet buckles 59 are unlatched and the hook extensions 52 are swung over to leave the straps 56 in the keepers 57, therefore exposing the support means 50 into a receiving position (see FIGS. 11 & 12) for wheels 72, 74;
7. The front end of the bicycle is raised such that the front wheel 72 is located in the support means 50 on the arm 44;
8. The rear end of the bicycle is raised such that the rear wheel 74 is located in the support means 50 on the arm 44;
9. The straps 56 are both removed from keepers 57, passed over the wheel and secured tightly to ratchet buckles 59;
10. The bicycle 70 is now suspended at the side of the vehicle, ready to be elevated onto the roof mounting;
11. The bicycle 70 is grasped by the lowest part of its frame and is lifted with a press manoeuvre to the roof 5 of the vehicle 6 to rotate the beam 12 until the lever 31 reengages the cross pin 17 of yoke 18 to lock the bicycle to prevent any unplanned descent of the bicycle; in this direction toward the parked position the damper is typically free to retract without any damping reaction there from;
12. The locking bar 20 is then replaced into its locking position;
13. The front and rear wheels 72, 74 are placed into the respective cradles 61 and the straps 62 secured.

The dismounting of the bicycle is essentially the reverse of the steps set forth above, namely:
1. The straps 62 are undone and the wheels are removed from their cradles 61;
2. The locking bar 20 is hinged out of its locking position;
3. The knob 37 is pulled outwardly to release the lever 31 against its resilient bias 33 from the cross pin 17;
4. The bicycle 70 carried by the support arms 44 will now descend under gravitational force in a controlled manner damped by the hydraulic damper 14, the beam 12 pivoting about the hinge pin 10;
5. The straps 56 are sequentially undone and put through keepers 57;
6. The rear wheel 74 is removed from the support means 50 first to provide better balance and is placed on the ground;
7. The front wheel 72 is then removed from the support means 50 and is placed on the ground;
8. The bicycle 70 is moved aside;
9. The hook extensions 52 are swung over and ratcheted with straps 56 engaging the buckles 59;
10. The right hand support arm 44 is then pulled sufficiently to disengage the detent 46 (see FIG. 8) and is pivoted (see FIG. 9) toward the centre of the assembly and released during pivoting movement (see FIG. 10), and a similar movement is effected on the left hand support arm and both arms are folded;
11. The arms are then pushed upwardly with the beam 12 pivoting about the hinge pin 10 until the lever 31 locks onto the cross pin 17;
12. The locking bar 20 is then pivoted towards the side to engage over the arms 44 to lock the same in a safe position.

As will be appreciated from the foregoing description of the operation of the bicycle carrier of the invention, the task of mounting the bicycle to the carrier is facilitated by the damped pivoting of the support arms that are stowable when not in use. Furthermore since it is the top of each wheel that is effectively grasped by the first wheel support means in the initial mounting phase, it is relatively easy for anyone to hitch one wheel at a time onto the relevant arm and then to strap the same into a firm position. With both wheels firmly secured in this way, the user may then lift the balanced bicycle using the press manoeuvre to raise the bicycle over the vehicle until the locking lever engages the cross pin to secure the bicycle in the carriage position. Release of the bicycle from this position is safe in that the downward motion is damped.

The bicycle carrier of the present invention thus allows ease of use with a much lower degree of effort required than with conventional carriers. Moreover, it is versatile in terms of its ability to accommodate velocipedes of differing shapes and dimensions with the adjustability of the support arm positioning and of the wheel cradles.

It will be appreciated that whilst the bicycle carrier has been described as being manually operable, other embodiments may be provided with power assistance.

It will be understood that the disposition of the bicycle carrier on the vehicle is effected such that sufficient clearance is provided as to allow the unimpeded ascent and descent of the carrier arms without fouling the side of the vehicle. A degree of overhang to accommodate the factory after market roof rack may thus be necessary for this purpose, as illustrated by the two mounts 2 closest to the base frame 8 and spaced there from with spacer trusses 13a (see FIGS. 1a, 4 and 6) connected to the base frame 8 via a bottom T-section slot 40 thereof. In order to locally provide for additional attachment to the roof rack adjacent the base frame 8 especially under the weight of the carried bicycle, additional mounts 2a could be added, as shown in dotted lines in FIG. 1a.

Although not illustrated in the figures, the two support arms 44 could obviously be adjustable in length, such as telescopically for example, to allow the carrier to adapt to a larger group of bicycle sizes, such as to include most kid and adult size bicycles.

Although the present invention has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

I claim:

1. A bicycle carrier for releasably securing a bicycle to a roof rack of a vehicle, the bicycle carrier comprising a base frame securably mountable on the roof rack, a beam extending adjacent the roof rack longitudinally of the base frame and of the vehicle and rotatable relative thereto along a beam longitudinal axis lengthwise of the vehicle, a support arm spaced apart along the beam and pivotable relative thereto at a first end thereof between a stowed position adjacent the base frame and a deployed position, detent means associated with the support arm to retain the arm in the deployed position, first wheel support means disposed at a free second end of the support arm and adapted in use to clamp an upper region of a respective wheel of the bicycle to the arm, and second wheel support means provided on the beam for securing a lower region of the respective wheel to the beam, damper means associated with the beam for damping its rotational movement.

2. A bicycle carrier as claimed in claim 1 wherein said support arm is a first arm and said carrier further includes a second support arm spaced apart along the beam and pivotable relative thereto at a first end thereof, the detent means retaining the arms in the deployed position, the first wheel support means disposed at a free second end of respective the support arms and adapted in use to clamp an upper region of a respective wheel of the bicycle to the respective arm.

3. A bicycle carrier as claimed in claim 2 wherein said first and second support arms pivot toward each other in a close side-by-side substantially overlying relationship relative to one another when being folded and away in a space-apart substantially parallel relationship relative to one another when being deployed.

4. A bicycle carrier as claimed in claim 3 wherein a hinge pin is provided for the rotation of the beam relative to the base frame and is mounted therein.

5. A bicycle carrier as claimed in claim 3 wherein the beam is provided with arm positioning means for longitudinally adjust positioning of respective the support arms therealong.

6. A bicycle carrier as claimed in claim 5 wherein the arm positioning means is formed with T-section slots cut in longitudinal faces of the beam and extending lengthwise thereof.

7. A bicycle carrier as claimed in claim 6 wherein the support arms are provided with mounting brackets securable to the beam through the agency of T-bolts engaging said T-section slots.

8. A bicycle carrier as claimed in claim 7 wherein the beam is provided with wheel support positioning means for longitudinally adjust positioning of respective the second wheel supports therealong.

9. A bicycle carrier as claimed in claim 8 wherein the T-section slots further forms the wheel support positioning means and the second wheel support means are attachable to the beam through the agency of T-bolts engaging said T-section slots.

10. A bicycle carrier as claimed in claim 3 wherein the detent means are resiliently biased to effect automatic locking of the support arms into the deployed position.

11. A bicycle carrier as claimed in claim 3 wherein the first wheel support means are in the form of straps releasably securable to the upper peripheral region of the respective bicycle wheels.

12. A bicycle carrier as claimed in claim 3 wherein the second wheel support means are in the form of arcuate cradles provided with straps adapted for securing the respective bicycle wheels thereto.

13. A bicycle carrier as claimed in claim 1 wherein the damper means is in the form of a hydraulic cylinder.

14. A bicycle carrier as claimed in claim 3 and including locking means to secure the beam when in a parked position.

15. A bicycle carrier as claimed in claim 14 wherein the locking means comprises a hooked lever resiliently biased into engagement with a cross pin associated with the beam, and release means to effect disengagement thereof as desired.

16. A bicycle carrier as claimed in claim 14 in which the locking means includes a movement limiting means for limiting the rotational movement of the beam when in a depending position for loading and unloading the bicycle therefrom.

17. A bicycle carrier as claimed in claim 14 in which the locking means includes a locking bar associated with the damper means and the base frame, the locking bar being provided with a lock that in its locked mode secures the beam in an upright position in which the support arms are either folded into the stowed position or locked in the deployed position upstanding in relation to the beam when in use carrying the bicycle.

18. A bicycle carrier as claimed in claim 17 in which, when the support arms are folded into the stowed position, the lock when in its locked mode secures the beam in an upright position and the support arms in the stowed position.

19. A bicycle carrier for releasably securing a bicycle to a roof rack of a vehicle, the bicycle carrier comprising a base frame securably mountable on the roof rack, a beam extending adjacent the roof rack longitudinally of the base frame and of the vehicle and rotatable relative thereto along a beam longitudinal axis lengthwise of the vehicle, two support arms spaced apart along the beam and pivotable relative thereto at a respective first end thereof between a stowed position adjacent the base frame and a deployed position, detent means associated with the support arms to retain the arms in the deployed position, first bicycle support means disposed at a respective free second end of the support arms and adapted in use to clamp a respective upper region of the bicycle to the arm, and second bicycle support means provided on the beam for securing a respective lower region of the bicycle to the beam, damper means associated with the beam for damping its rotational movement.

20. A bicycle carrier as claimed in claim 19 wherein said first and second support arms pivot toward each other in a close side-by-side substantially overlying relationship relative to one another when being folded and away in a space-apart substantially parallel relationship relative to one another when being deployed.

21. A bicycle carrier as claimed in claim 19 wherein the first bicycle support means are first wheel support means disposed at a respective free second end of the support arms and adapted in use to clamp an upper region a respective wheel of the bicycle to the arm, and the second bicycle support means are second wheel support means provided on the beam for securing a lower region of a respective wheel of the bicycle to the beam.
